(19) United States
(12) Patent Application Publication
(10) Pub. No.: US 2024/0362966 A1
(43) Pub. Date: Oct. 31, 2024

(54) ATM DEPOSITORY ANTI-FRAUD KIT

(71) Applicant: Tecnologia Bancaria S.A., Barueri (BR)

(72) Inventor: Mauricio Vidal de Almeida, Sau Paulo (BR)

(21) Appl. No.: 18/648,382

(22) Filed: Apr. 28, 2024

(30) Foreign Application Priority Data
Apr. 28, 2023 (BR) 10 2023 008197 5

(51) Int. Cl. G07D 11/40

(52) U.S. Cl. CPC G07D 11/40; G07D 2211/00

(57) ABSTRACT

Disclosed herein is an anti-fraud kit comprising a metal protection plate (6) and an acetate plate (7) installed in the chest (4) of the depository module of the ATM equipment (1) with deposit services using envelopes (5), wherein the anti-fraud kit is used to prevent a fraud device (3), known as “Alligator Mouth”, from being able to remove the envelopes (5) containing cash from inside the chest (4) of the depositary module.

### FIELD OF APPLICATION

This specification describes an invention patent application for a mechanical device used to inhibit fraud that may occur in ATM (Automated Teller Machines) equipment with depository service.

### STATE OF THE ART

The state of the art features ATMs as equipment that allows withdrawals, deposits and transactions to bank customers.

### PROBLEMS WITH THE STATE OF THE ART

In ATM-type equipment (1) with a cash deposit service using envelopes (5) some fraud attempts exist, where it is possible to “pick up”, i.e., remove the envelopes from inside the ATM equipment. A specific type of this fraud, known as “Boca de Jacaré”, or Alligator Mouth, is usually practiced by introducing, through the envelope entry slot (2), a fraud device (3) that reaches the chest (4) of the depositary module where the envelopes (5) are stored. This fraud device (3) manages to pick up the envelope (5) and remove it through the envelope entry slot (2) of the ATM equipment (1), as can be seen in FIGS. 1 and 2 representing the state of the art.

This type of fraud causes insecurity for customers who use envelope deposit services and losses to financial institutions.

### OBJECTIVES OF THE INVENTION

This invention aims to inhibit the action of fraud in order to prevent envelopes from being removed and discourage new attacks, allowing customers to use the envelope deposit service safely.

### BRIEF DESCRIPTION OF THE INVENTION

In view of the problems with the state of the art, an anti-fraud kit was developed comprising a metal protection plate fastened to the chest of the depository module of the ATM equipment using screws and nuts and an acetate plate fastened using double-sided tape on the opposite side of the chest to the fastening of the metal protection plate.

By installing the anti-fraud kit, equipment operation will remain unchanged, and the depository module chest will receive cash deposit envelopes normally. The acetate plate is installed on the internal wall of the chest to allow the envelope to be directed to the bottom of the chest without resting or tangling in any protruding points, such as, for example, rivets, nuts or screws.

For attacks with the fraud known as “Alligator Mouth”, the fraud device is introduced by the envelope entry slot opening and goes to the depositary module chest, where the cash envelopes are kept. The purpose of installing the metal protection plate on the upper part of the chest entry opening of the depository module is to prevent the fraud device from reaching the envelopes; however, if the fraud device manages to reach the envelopes, the metal protection plate will prevent the envelopes from being removed, since when trying to pull out the fraud device, the envelope and fraud device will get stuck in the openings and cutouts of the metal protection plate, and the tape of the fraud device may also be broken in order to keep part of the device and the envelope containing the banknotes inside the depository module chest.

### ADVANTAGES OF THE INVENTION OVER THE STATE OF THE ART

The anti-fraud kit proposed herein is simple to produce, and quick and easy to install in the already existing state-of-the-art ATM equipment.

After installing the anti-fraud kit, no additional training or guidance is required for customers to use the ATMs, nor for employees of financial institutions or cash-in-transit companies to operate ATM equipment during the collection of envelopes from the depository module chest.

### BRIEF DESCRIPTION OF THE DRAWINGS

In order to complement this description, so as to obtain a better understanding of the features of the “ATM DEPOSITORY ANTI-FRAUD KIT” and in accordance with a preferred practical embodiment, a set of drawings is attached hereto, where in an exemplary, but not limiting way the following is depicted:

FIG. 1 schematically illustrates the type of fraud known as “Alligator Mouth”, present in the state of the art.

FIG. 2 schematically shows, in a perspective view, how the fraud device accesses the depositary module chest to remove envelopes in a state-of-the-art ATM without the device proposed herein.

FIG. 3 features a front orthogonal view of the protection plate blank.

FIG. 3A shows an enlarged view of “Detail A” indicated in FIG. 3.

FIG. 3B features an enlarged view of “Detail B” indicated in FIG. 3.

FIG. 4 features the front orthogonal view of the anti-fraud kit protection plate of the depositary module after the bending operations.

FIG. 5 illustrates the side view of the protection plate after the folds.

FIG. 6 shows the top view of the protection plate after the folds.

FIG. 7 features an isometric perspective view of the protection plate and fastening elements.

FIG. 8 shows a perspective view of the acetate plate with the double-sided tape.

FIG. 9 illustrates the front orthogonal view of the acetate plate, highlighting the removal of the double-sided tape layer.

FIG. 10 features the lateral orthogonal view of the acetate plate.

FIG. 11 shows a perspective view of the ATM equipment chest for receiving envelopes.

FIG. 12 features a perspective, cross-sectional view of the chest with the anti-fraud kit protection plate installed.

FIG. 13 shows a side, cross-sectional view of the chest with the anti-fraud kit protection plate installed.

FIG. 14 features a perspective, cross-sectional view of the chest with the acetate plate installed.

FIG. 15 shows a side, cross-sectional view of the chest with the acetate plate installed.

FIG. 16 shows a perspective view of the chest, showing how the acetate plate directs the envelope so that it does not get tangled in protrusions and is directed towards the lower part of the chest for receiving envelopes, and

FIG. 17 schematically illustrates a case in which the anti-fraud kit protection plate prevents the removal of an envelope from inside the depository module chest.

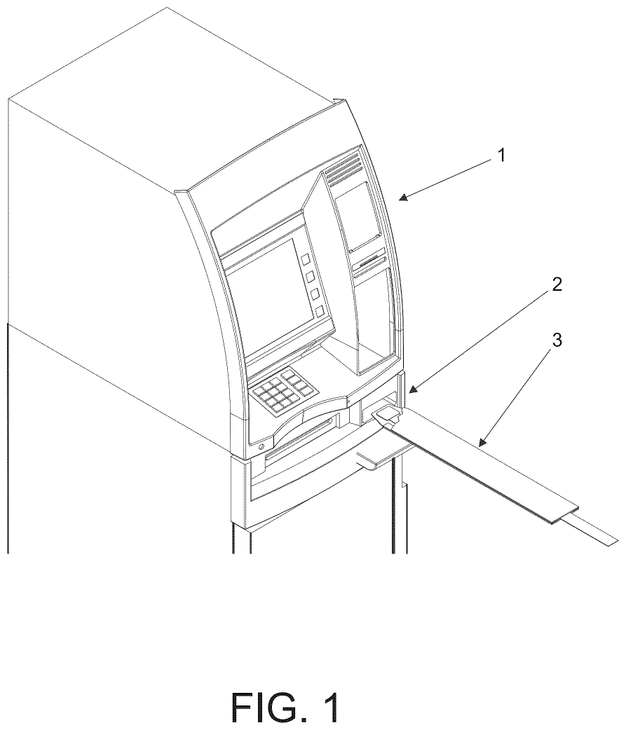

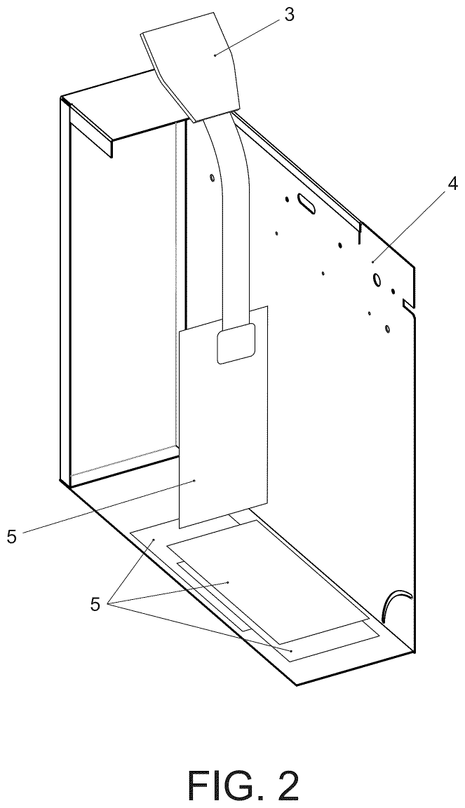

### REFERENCE SIGNS

The “ATM DEPOSITORY ANTI-FRAUD KIT” will be better described by means of the following reference signs:
(1) Automated Teller Machine (ATM)
(2) Envelope entry slot
(3) Fraud device (“Alligator Mouth”)
(4) [Depositary module] chest
(5) Envelope
(6) Protection plate
(7) Acetate plate
(8) Blank
(9) Upper portion [Blank/Protection Plate]
(10) Intermediate portion [Blank/Protection Plate]
(11) Lower portion [Blank/Protection Plate]
(12) Rectangular cutout [Blank/Protection Plate]
(13) Oblong Hole [Blank/Protection Plate]
(14A, 14B, 14C, 14D) Circular Hole [Blank/Protection Plate]
(15A, 15B) Circular hole [Blank/Protection Plate]
(16) Recess
(17) Pointed triangular tooth
(18) Triangular tooth with rounded tip
(19) Arrow-shaped protrusions
(20) Rectangular cutouts
(21) Pointed triangular protrusions
(22) Screw
(23) Nut
(24A, 24B, 24C, 24D) Circular Hole [Chest]
(25) Double-sided adhesive tape
(26) Layer [Double-sided tape removable film]
(27) Dashed line [fold line between the upper and middle portions of the blank]
(28) Dashed line [fold line between the middle and lower portions of the blank], and
(29) Protruding portions.

### DETAILED DESCRIPTION OF THE INVENTION

The “ATM DEPOSITORY ANTI-FRAUD KIT” comprises a protection plate (6), an acetate plate (7) and fastening elements.

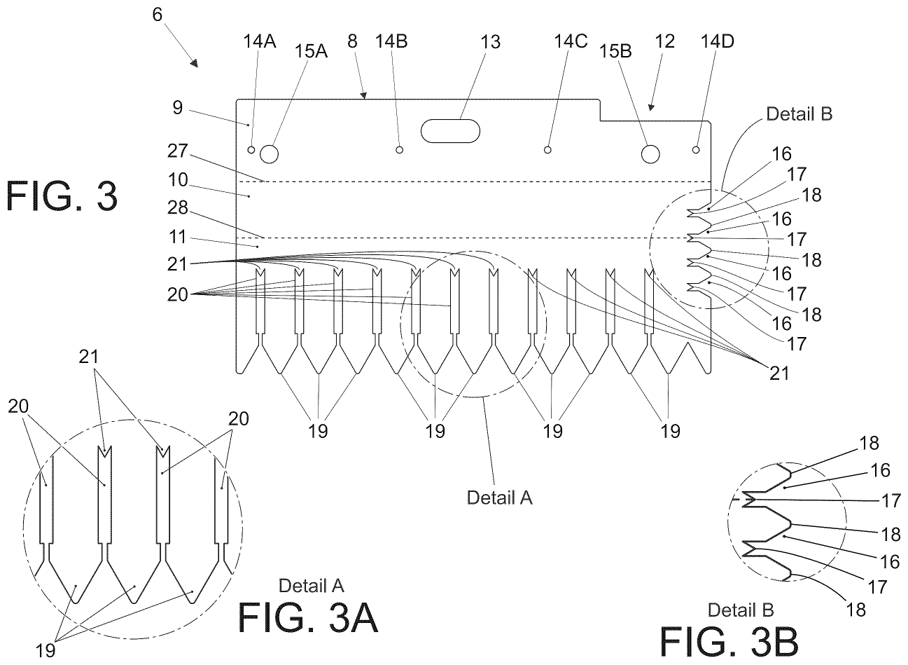

The protection plate (6) is made from a blank (8) of metallic material from the group consisting of stainless steel, 1020 galvanized steel, aluminum, copper, bronze and brass, preferably stainless steel, machined (tooling-made) or stamped and provided with an upper portion (9), an intermediate portion (10) and a lower portion (11), wherein said upper portion (9), intermediate portion (10) and lower portion (11), as shown in FIG. 3, are separated by dashed lines (27) and (28), respectively.

The upper portion (9) has a rectangular cutout (12) in the upper right corner thereof; an oblong hole (13) disposed horizontally in the middle part thereof at a horizontal direction; and in the lower part thereof, circular holes (14A, 14B, 14C, 14D) arranged horizontally and equidistantly spaced from each other and two circular holes (15A, 15B), having a larger diameter than the circular holes (14A, 14B, 14C, 14D), the circular hole (15A) being arranged between the circular holes (14A) and (14B), close to the circular hole (14A), and the circular hole (15B) being arranged between the circular holes (14C) and (14D), close to the circular hole (14D).

The intermediate portion (10) has a profile in the right part thereof, comprising recesses (16) with pointed triangular teeth (17) and triangular teeth with rounded tips (18), such profile being repeated until the horizontal half of the right lower portion (11) of the blank (8), which can be seen in FIG. 3 and are shown in detail in FIG. 3B.

The lower portion (11) has arrow-shaped protrusions (19) facing downwards, which are provided with rectangular cutouts (20) having pointed triangular protrusions (21) in the upper portions thereof, which are shown in FIG. 3 and can be seen in enlarged detail in FIG. 3A.

The protection plate (6) final configuration is achieved by bending processes in the dashed lines (27) and (28) shown in FIG. 3, which respectively indicate the division between the upper portion (9) and the intermediate portion (10) and the division between the intermediate portion (10) and the lower portion (11).

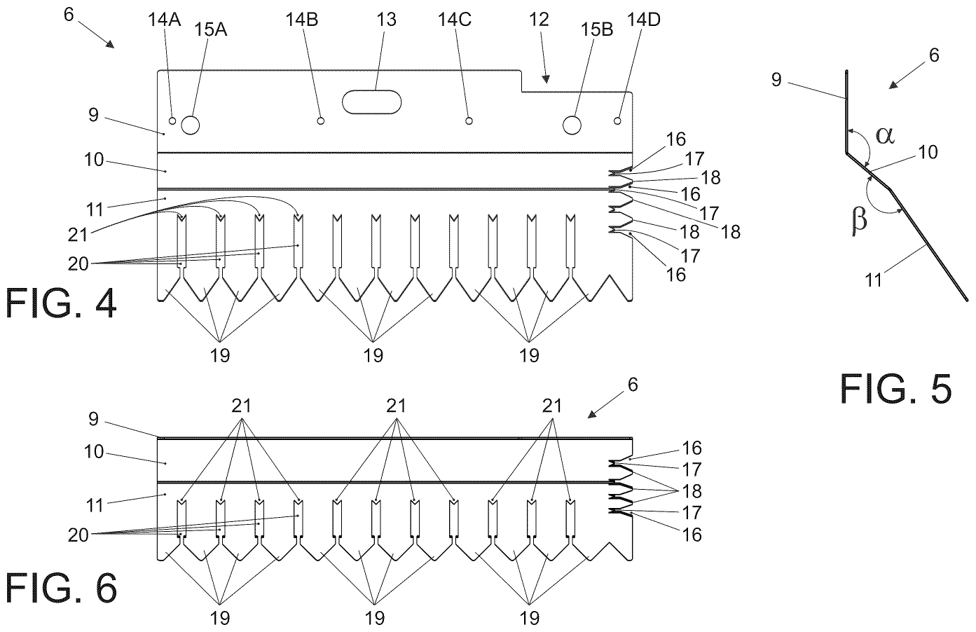

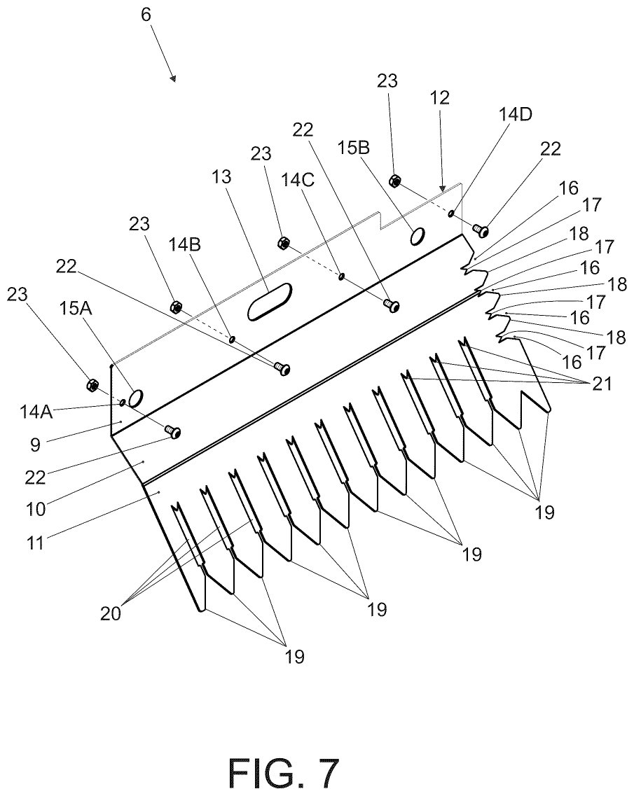

Said folds are consecutive, at obtuse angles α and β that form the upper portion (9) as a vertical portion, the intermediate portion (10) as a portion inclined counterclockwise in relation to the upper portion (9), and the lower portion (11) as a portion inclined clockwise in relation to the intermediate portion (10), as can be seen in FIGS. 4, 5, 6 and 7.

Angle α is between 125° and 135°, preferably 130°, and angle β is between 160° and 170°, preferably 165°.

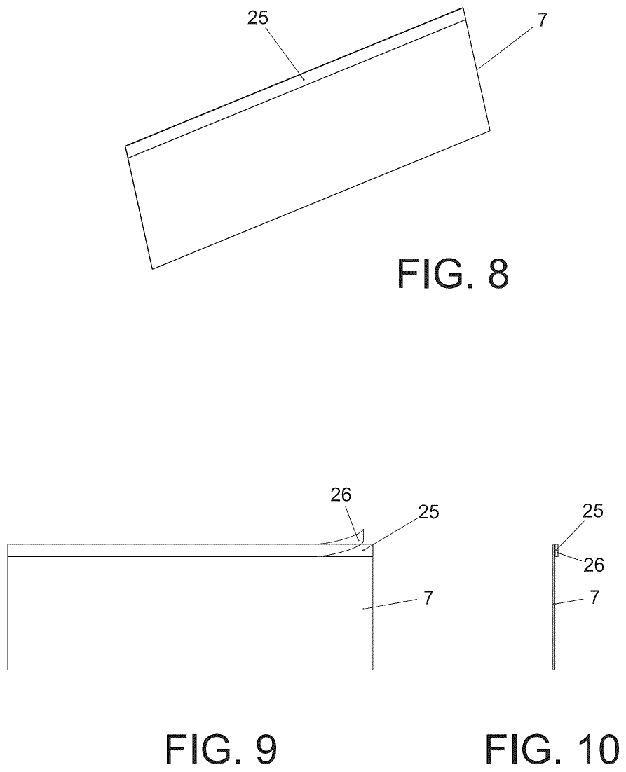

The acetate plate (7) is rectangular-shaped and has a double-sided tape (25) in the upper portion thereof, as can be seen in FIGS. 8, 9 and 10.

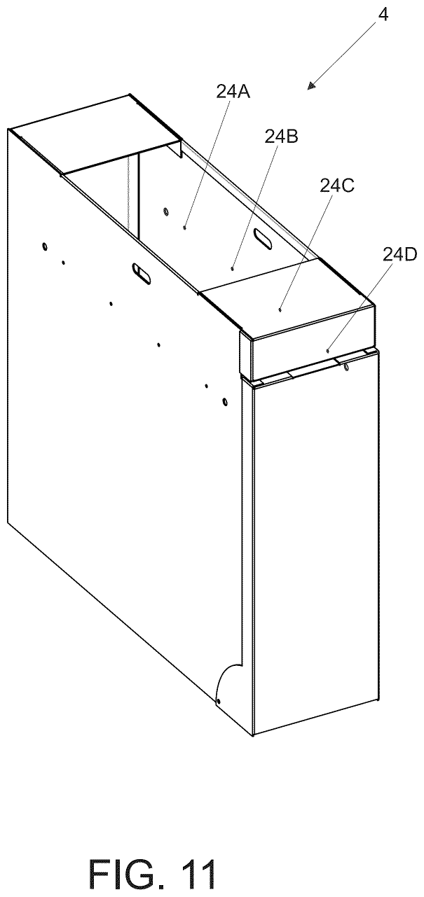

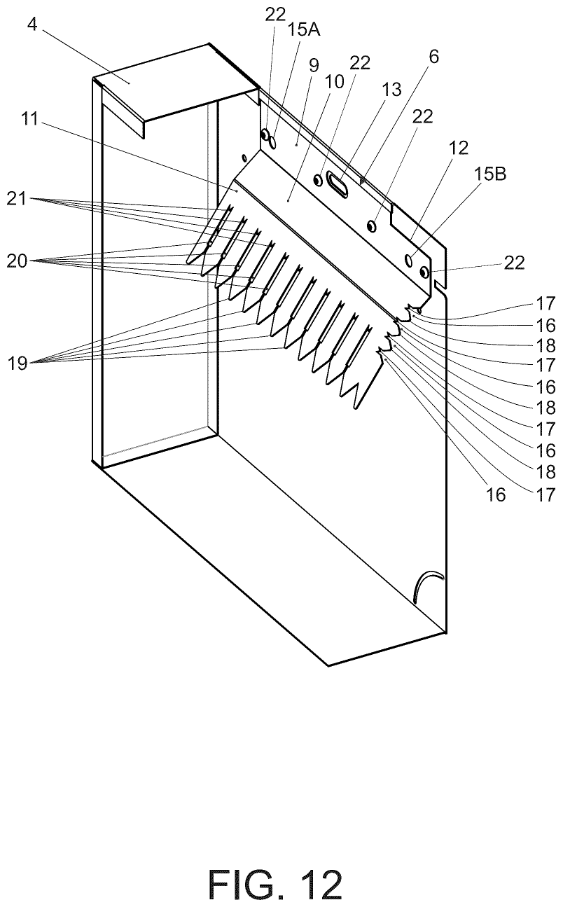

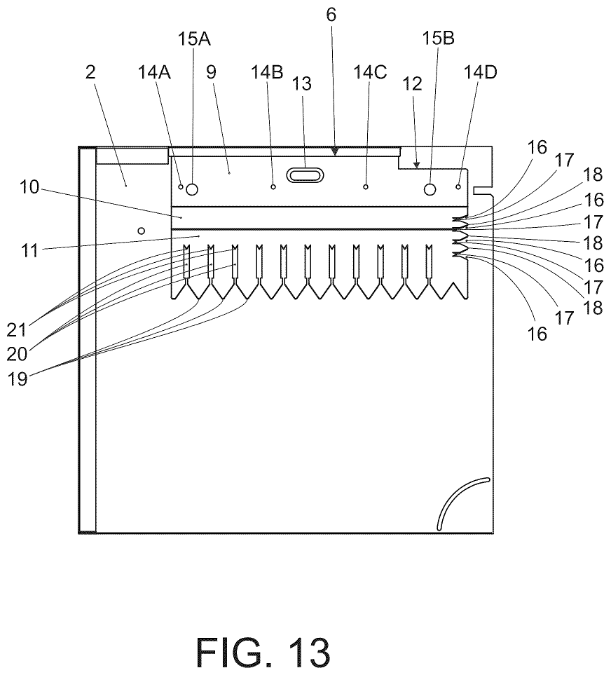

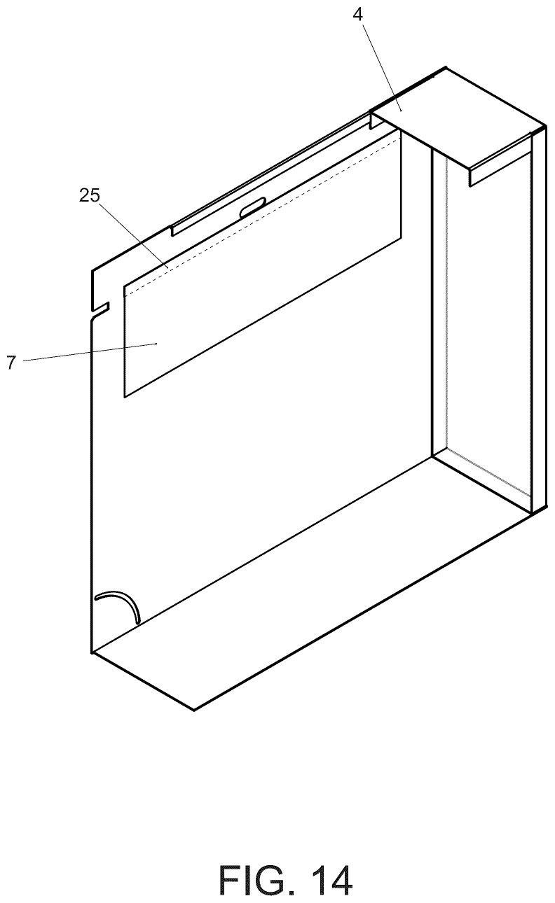

The fastening of the protection plate (6) to the chest (4) of the depositary module is performed using screws (22) and nuts (23) installed in the circular holes (14A, 14B, 14C, 14D) of the protection plate (6) and respective holes (24A, 24B, 24C, 24D) present in the chest (4) of the depository module, which are shown in FIGS. 11, 12 and 13.

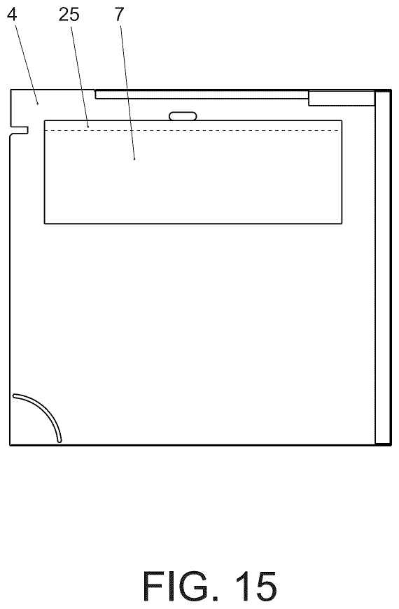

The fastening of the acetate plate (7), made on the internal face opposite to the installation of the protection plate (6), is performed by removing the layer (26) of the double-sided tape (25) and positioning it over the area with protruding portions (29), such as rivets, screws or nuts, as schematically shown in FIGS. 14, 15.

The principle of operation of the anti-fraud kit proposed herein is as described below.

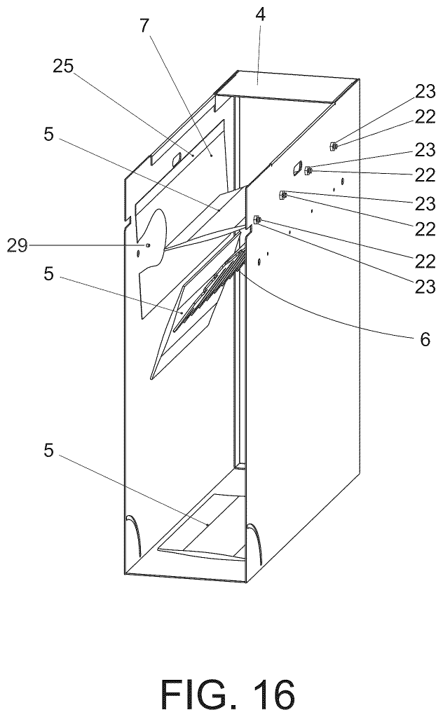

The acetate plate (7) has the function of directing the envelope correctly into the chest (4) of the depository module, in order to prevent any envelope (5) from being retained above the protection plate (6), by tangling on some internal component having a protruding portion (29) on the internal part of the chest (4), as shown in FIG. 16.

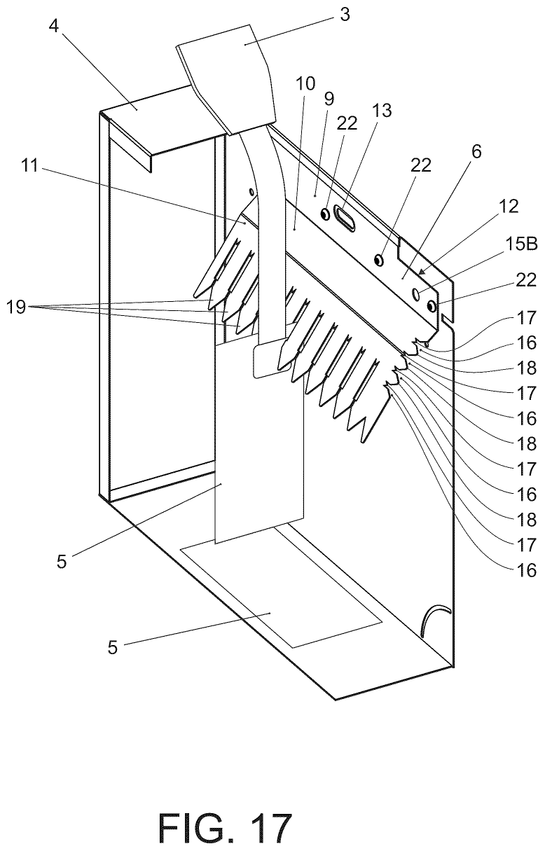

If the fraud device manages to pass through the protection plate (6) on its path into the chest (4), the profile comprising recesses (16) with pointed triangular teeth (17) and triangular teeth with rounded tips (18) arranged on the right side portion of the protection plate (6) or the arrow-shaped protrusions (19) provided with rectangular cutouts (20) having pointed triangular protrusions (21) among them will retain the envelope and/or breaking the fraud device (3) on its return path, in order to disable the fraud device (3) and keep the envelopes (5), which contain the banknotes, inside the chest (4) of the ATM (1), thus preventing fraud, i.e., preventing the removal of the envelopes (5) with the banknotes, as shown in FIG. 17.

### Glossary

Blanks-Refer to unfinished metal pieces obtained by cross-cutting coils and metal plates, which undergo a modeling process in tools and machines until they are transformed into different objects. TETRAFERRO. “Blanks”. Available at: <https://tetraferro.com.br/blanks/>. Accessed on Apr. 25, 2023.

1. An ATM DEPOSITORY ANTI-FRAUD KIT, comprising a protection plate (6), screws (22), nuts (23) and a rectangular acetate plate (7) having in the upper longitudinal portion thereof a double-sided adhesive tape (25), wherein the protection plate (6) is made from a blank (8) of metallic material from the group consisting of stainless steel, 1020 galvanized steel, aluminum, copper, bronze and brass, preferably stainless steel, machined or stamped and provided with an upper portion (9), an intermediate portion (10) and a lower portion (11), wherein the upper portion (9) has a rectangular cutout (12) in the upper right corner thereof; an oblong hole (13) disposed horizontally in the middle part thereof at a horizontal direction; and in the lower part thereof, circular holes (14A, 14B, 14C, 14D) arranged horizontally and equidistantly spaced from each other and two circular holes (15A, 15B), the circular hole (15A) being arranged between the circular holes (14A) and (14B) and the circular hole (15B) being arranged between the circular holes (14C) and (14D); the intermediate portion (10) has a profile in the right part thereof, comprising recesses (16) with pointed triangular teeth (17) and triangular teeth with rounded tips (18), such profile being repeated until the horizontal half of the right lower portion (11) of the blank (8); the lower portion (11) has arrow-shaped protrusions (19) facing downwards, which are provided with rectangular cutouts (20) having pointed triangular protrusions (21) in the upper portions thereof; the blank (8) of the protection plate (6) is formed by bending processes in the dashed lines (27) and (28), wherein the bends are consecutive, in obtuse angles α and β, wherein the angle α is between 125° and 135°, preferably 130°, and angle β is between 160° and 170°, preferably 165°.

2. The ATM DEPOSITORY ANTI-FRAUD KIT, according to claim 1, wherein the protection plate (6) is fastened to the depository module chest (4) by screws (22) and nuts (23) installed in the circular holes (14A, 14B, 14C, 14D) of the protection plate (6) and respective holes (24A, 24B, 24C, 24D) of the chest (4) of the depositary module.

3. The ATM DEPOSITORY ANTI-FRAUD KIT, according to claim 1, wherein the acetate plate (7) is fastened on the internal face opposite to the installation of the protection plate (6), on the area with protruding portions (29).
